(19) United States
(12) Patent Application Publication
(10) Pub. No.: US 2009/0216591 A1
(43) Pub. Date: Aug. 27, 2009

(54) METHOD FOR COMPUTER EVALUATION OF CUSTOMER INFORMATION AND AUTOMATICALLY PROVIDING CUSTOMIZED FINANCIAL PRODUCT OFFERS THERETO

(75) Inventors: David A. Buerger, Santa Rosa, CA (US); Darin L. Chong, Santa Rosa, CA (US); John Reich, Healdsburg, CA (US)

Correspondence Address: Eugenia S. Hansen;Hemingway & Hansen, LLP, Comerica Bank Tower Suite # 2500, 1717 Main Street, Dallas, TX, 75201, US

(73) Assignee: CUneXus, New Braunfels, TX (US)

(21) Appl. No.: 12/389,858

(22) Filed: Feb. 20, 2009

Related U.S. Application Data
(60) Provisional application No. 61/030,710, filed on Feb. 22, 2008.

(51) Int. Cl. G06Q 10/00

(52) U.S. Cl. 705/7

(57) ABSTRACT

This invention relates to the field of computer-assisted methods for customer data evaluation and communication of customized sales offers of financial products to customers based on data evaluation.

In a preferred embodiment, a system comprising a software module generates pre-approved financial product offers, such as credit offers, after evaluating information retrieved from internal and/or external databases which contain customer information. The system is particularly suitable for generating pre-approved multi-product offers from the suite of products a user institution has available in addition to a default offer.

### CROSS REFERENCE TO RELATED APPLICATIONS

This application claims the benefit of U.S. Provisional Patent Application 61/030,710, filed 22 Feb. 2008.

### STATEMENT REGARDING FEDERALLY SPONSORED RESEARCH OR DEVELOPMENT

Not applicable.

### TECHNICAL FIELD OF INVENTION

This invention relates to the field of computer-assisted methods for customer data evaluation and communication of customized sales offers of financial products to customers based on data evaluation.

### BACKGROUND OF THE INVENTION

Rapid advancements in technology and process automation have ushered in a new age of operational efficiency, consumer expectation, and business strategy within the financial services industry. In recent years, software has been developed to assist lenders in making loan decisions. Such software has contained, for example, tools that automate underwriting and risk-based lending procedures. Due to such tools, consumers now have the ability to gain loan approval rapidly, either online or in-person at their financial institution.

In order to market to their pre-existing customers, financial institutions have widely used a practice of extending pre-approved loan offers (often via mail) directly to consumers. Current methods, however, require lenders to obtain a separate credit pre-screen for each pre-approved product offering. For example, if a lender wishes to pre-approve an individual for more than one product or product category, separate credit reports, underwriting and communication/delivery processes are generally obtained. Furthermore, these traditional methods fail to integrate all available delivery channels and customer touch points, and are often communicated to potential customers solely via direct mail. Many consumers find these direct mail initiatives to be bothersome and invasive, regarding such communication as “junk-mail.” There is a need for improved systems and methods for use by financial institutions and other companies that have the need or desire to qualify customers and communicate offers to customers concerning the availability of financial products and services for which they have been qualified.

### BRIEF DESCRIPTION OF THE DRAWINGS

FIG. 1 is a flowchart of a software module employed by a system of the invention.

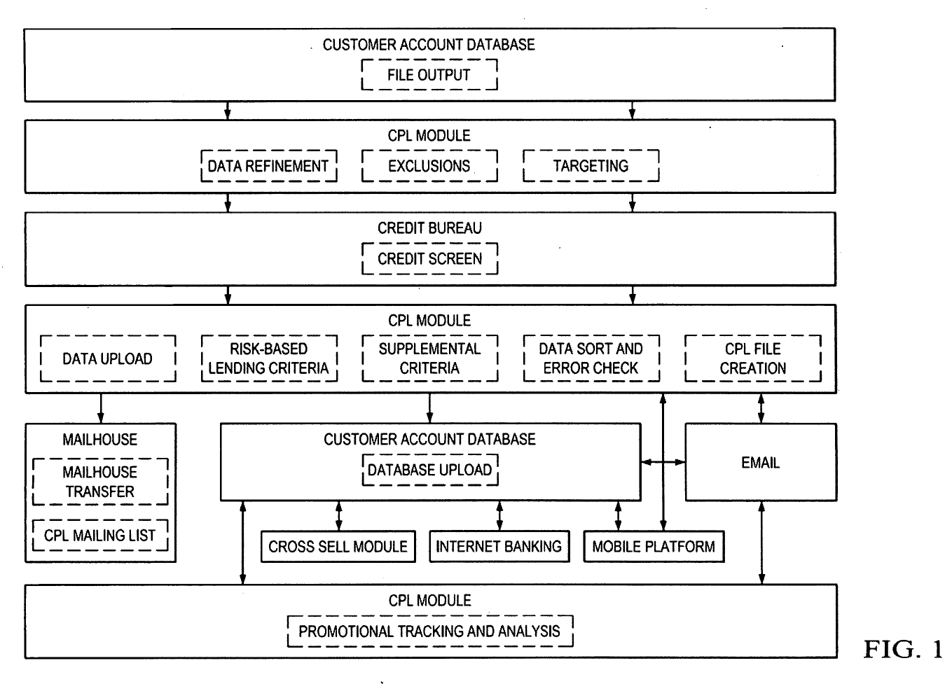

FIG. 2 is a flowchart which provides an example as to how the final profile codes are created.

### DETAILED DESCRIPTION

Herein disclosed is a system employing a computer-assisted method or module for managing the process of utilizing pre-existing customer data and a single credit pre-screen to extend multi-product, cross-category pre-screened credit offers in an automated manner.

The system is especially appropriate for use by financial institutions, insurance providers, and other companies which want to offer products or services to a customer or customer base as to which customer data is available, which customer data can be used to determine the nature of the financial offer that the company wishes to extend. A portion of the customer data will likely reside in the company's own databases and thus the system is advantageous for use by companies that want to market offers to their pre-existing customers. Another portion of the customer data will likely reside in outside sources such as credit bureaus. It is envisioned however, that in some cases the customer data can reside in total in outside sources.

For ease of discussion, the system of the invention will be referred to with respect to the offering of financial products, even though it should be understood that other products can be offered as well.

Criteria as to what characteristics a customer must have to be extended particular offers are generally set by the company making the offer. For example, offers as to financial products such as loans, credit cards, mortgages, insurance and the like can benefit from the system of the invention. The criteria set internally by the financial institution may involve the types of loans it has decided to make available from its institution, for example home mortgages, auto loans and boat loans. One of the criteria is generally the credit-worthiness of the customer which is often referred to as the credit score of the customer. The credit score may and generally does reside in outside sources such as credit bureaus.

The system of the invention provides a computerized analysis of customer data from internal company sources and correlates it with any data obtained from outside sources, such as credit bureaus. After the analysis is accomplished, the system is able to provide customized offers to customers that are based on the company-set criteria and the company's products. Further, the system provides for communication of the customized offers to the customer. In addition, the system provides for reassessment of the offers not accepted by the customer upon acceptance of one or more offers, generation of new offers, and tracking of offers accepted by the customer.

There are many advantages provided by the system of the invention. The system of the invention increases the response rate by customers. Further, it increases the return on investment (ROI) for the user institutions that employ it and reduces man-hours needed to make a determination as to the nature of the offers customers should be provided. The system is suitable for use by all user institutions, e.g. lenders, but is especially suitable for small and mid-sized lenders who may not have the resources and/or man power to implement effective pre-screened lending programs. In a preferred embodiment, the system further provides a functionality which allows the user institution to monitor customer acceptance of offers and/or to redetermine the nature of offers provided to customers in real-time. This functionality may be known as a real-time results tracking and report generator. In another preferred embodiment, the system comprises an interface between the system and user institution departments such as loan fulfillment and/or retail and phone centers. This interface allows the user institution to more effectively cross-sell its products due to receiving real time data concerning customer interests and customer profiles and to fund loans promptly.

The system provides tools to effectively customize the nature of the financial product(s) offered to particular recipients, to increase the size of the group that lenders are able to contact with per unit amount as compared to prior methods, to provide the lender with cross-selling marketing capabilities and to provide the lender with the means to utilize on-line and wireless channels for example mobile communication devices, email, online banking, etc.

The system is able to increase the size of the customer base contacted as compared with prior methods. The system may result in cost savings over prior manual or semi-manual methods, and these savings can be reallocated to enable the financial institution to extend the combined offers to a much larger audience, for example the lender's entire customer base, thus realizing greater marketing and promotion per unit amount expended.

Further, multi-product promotion enabled by the system has a number of advantages. Customers are offered various products, increasing the chances that one of the products meets their needs at a particular time. Promotions can be offered on a continuous basis, so that customers can access pre-approved loans at any given time. The financial institution benefits in that these continuous offers position the institution as their customer's “lender-of-choice.” Loan applications are unnecessary as to the pre-approved products, as the lender's entire suite of loan products are available to pre-approved individuals at an on-demand, or nearly on-demand, basis. User financial institutions can offer their clients the convenience of remaining pre-approved for an array of offers at all times.

In a preferred embodiment, the system of the invention is implemented by a software module which is or can be loaded into a computer system and which software enables a method that can be carried out continuously, with little or no human intervention from one step to another. In such embodiment, all results of the individual data derivation steps or correlations are communicated electronically to a subsequent processing step up to the time of communication of the offer to the customer.

In utilizing the system of the invention, the user financial institution can pre-screen a customer and determine appropriate offers to extend to a customer regarding a user-designated suite of financial products. The user-designated suite of financial products preferably contains all of the products offered to any of its customers. The user-designated suite may for example include products that heretofore rarely or never were promoted via pre-approval.

The system provides functionality to determine offers for all customers in the user database, or a subset of customers defined as being of interest by the user, as to all products in the user-defined suite in a single process.

In addition, the system preferably provides functionality for generating variable pre-approval decisions for different products in the user-defined suite. A series of matrices are utilized to create customized product offers, based on each individual customer's unique product relationship with the lending institution and several pieces of information provided within their credit report as is further detailed below.

The system first comprises gathering customer data stored in a database or databases. In addition to customer identification information, the unique product relationship with the user institution is noted.

In a preferred embodiment, a secure file transfer protocol (FTP) data transmittal interface is provided which assists in securing any data that is transmitted from the user institution to an outside vendor.

One embodiment comprises a stand alone software package which may be loaded on a stand alone computer. The computer on which the software is loaded can be in electronic communication with the user institution's core processing system and may receive data there from through the communications means between the computers. Alternatively, data from the core processing system may be transferred to an intermediate source, such as a data reception site or a memory storage device, then to the stand alone computer.

In the stand alone software package, a universally exportable and importable data format is preferably employed so that data from the financial institution's core processing system can be collected in a form that can be recognized by the stand alone software package of the invention. A preferred universally exportable and importable data format such as a text file for example txt. This format is commonly used in business and therefore providing software that can import data from this format for further analysis is cost-efficient and convenient. The software may also be provided with the capability to import data in other formats generated by the core processing unit.

Another embodiment is a custom built system designed to be incorporated into a given user institution's core processing system which is compatible or a part of the operating software of the core processing system. In this embodiment, each interface required is individually programmed.

Another embodiment is a functionality which can be incorporated into a software suite or operating system designed to fulfill multiple needs of a user institution. In such an embodiment, the functionality is provided to the developer of the software'suite or operating system for incorporation therein.

Another embodiment is a web-based system wherein the functionality of the invention can be utilized by a user institution by accessing the web-based system.

Still another embodiment is providing the functionality of the invention to an entity with which the user institution does business in the course of preparing its pre-approved credit offers, such as an independent credit bureau. In such case, the user institution will provide data to the credit bureau which will perform the steps of the method to provide the desired final information to the financial institution or its designee.

Regardless of the embodiment employed, the method performed by the system of the invention follows the following further steps. After, the necessary customer data is collected as discussed above from for example a user institution's internal database located in a core processing system and/or external databases, the customer data is transferred to the system of the invention.

In one embodiment, the system can be provided with or programmed with the user institution's criteria for marketing, lending and underwriting. This can be provided to the system through initial set up of the system through a user interface. This functionality would allow the user institution to alter its criteria at any time internally. In addition, the user institution can customize its underwriting criterion much more specifically. For example, it can specify different underwriting flexibility for different codes. The system can then communicate particularized criteria to an outside service vendor credit bureau on an ongoing or real time basis.

In an alternative embodiment, the underwriting criteria will reside in the computer systems of outside service vendors, such as credit bureaus. The user institution generally will send criteria to the credit bureau at a particular time, and the criteria will remain unchanged until the user institution communicates new criteria.

In still another embodiment, the system further comprises a functionality that provides forms that can be completed by the user institution to specify underwriting criteria for communication to the credit bureau. The forms can be communicated via an interface provided by the credit bureau or emailed, faxed, mailed or otherwise sent to the credit bureau for input into its computer systems which will be used to generate the data required by the user institution for analysis by the system of the invention.

The customer data is analyzed via an algorithm within a software routine within the system programmed to generate a coded customer relationship profile (CRP). The algorithm takes into account the existing accounts for each individual customer, product/service relationship data (to which a code may or may not have been pre-assigned by the user), account information, and unique identifiers.

Output may include CRPs for the entire customer base, or CRPs can be requested for a more limited subset of the customer base, such as a specific segment or segments or for an individual customer.

The system utilizes the CRP data set for creating a credit bureau input data set. A software routine in the system is programmed to create the credit bureau input set.

Individual CRPs within the credit bureau input data set are assigned a preliminary profile code by the system. This is arrived at by providing said data to a software routine that is programmed to generate the preliminary profile codes by taking into account the individual customer's current product relationships and how they relate to the institution's product offerings.

This preliminary profile code can be assigned before the credit bureau input data is sent to the credit bureau or when the data set returns from the credit bureau after being associated with the customer's credit score. The preferred method is to assign the preliminary profile code to the credit bureau input data to better ensure quality, security and accuracy.

In a preferred embodiment, the CRP data is refined to form the credit bureau input data set via a software routine in said CPL module that is programmed to take one or more refining characteristics into account. This refinement can include, for example, exclusion of individual customers or customer sets. Exclusion criteria may include demographic considerations and/or product/service relationship data contained within CRPs. The refinement step may also be bypassed, so that output data set includes entire customer base (less any exclusions provided for in the CRP generation step),

As is evident from the above, exclusions can be made in one or more steps. The initial set exclusions are considered to be necessary exclusions as defined by the institutions lending criteria—such as the presence of past bankruptcy, delinquent loans, etc. The second set of exclusions are generally more in the realm of marketing and consumer targeting decisions, such as age, geographic area, income, etc. These considerations are optional on the part of the marketer and do not relate to any predefined underwriting/lending parameters.

The credit bureau input data set is encrypted and transmitted to a credit bureau. The credit bureau appends the credit score and other information that it may have such as beacon score, BNI, and tradeline info such as presence of mortgage and mortgage balance to the data set provided to it. The user institution does provide basic underwriting criteria to the credit bureau, generally their minimum approval qualifications. For instance, the lender will indicate that they only wish to pre-approve individuals with a beacon score of at least 640 and a BNI of at least 280 (this is variable, based on the lenders specific eligibility criteria). The credit bureau will then extract the necessary information from the data set and run a pre-screen on all prospective offerees of the user institution's products in the data set, removing all offerees that do not meet the criteria. The credit bureau output set returned to the system will in this preferred embodiment only include information on those who qualified.

In a preferred embodiment, the system includes a function of automated underwriting. In another embodiment, the pre-screen is run through a separate process, and the credit bureau output set entered into the system upon receipt.

If opened in a spreadsheet format, the text files' appended information from the credit bureau appears in the credit bureau output set as additional “fields.” The actual fields populated by the credit bureau can change upon request of the user institution.

For example, if one opens the transmitted text in a spreadsheet program, column 1 may be last name, column 2 is first name, column 3 address, column 4 a coded social security number and columns 5-9 could be the fields that the credit bureau completes. As one example, these columns could be column 5 beacon score, column 6 BNI, column 7 first mortgage balance, column 8 original mortgage balance, column 9 monthly mortgage payment.

The credit bureau returns a credit bureau output data set appended with credit score information (Beacon and/or BNI). The returned credit bureau output data set will preferably include home ownership status for each individual (presence of mortgage, mortgage balance, and monthly payment). Other information regarding open trade lines may be requested for evaluation as well, depending on the needs of the institution.

The credit bureau output data set retrieved from the credit bureau is uploaded to the system for processing via a software routine that is programmed to correlate said credit bureau output data with said preliminary profile code. Credit score data and any mortgage information are appended to said preliminary profile code, thus generating a final profile code assignment.

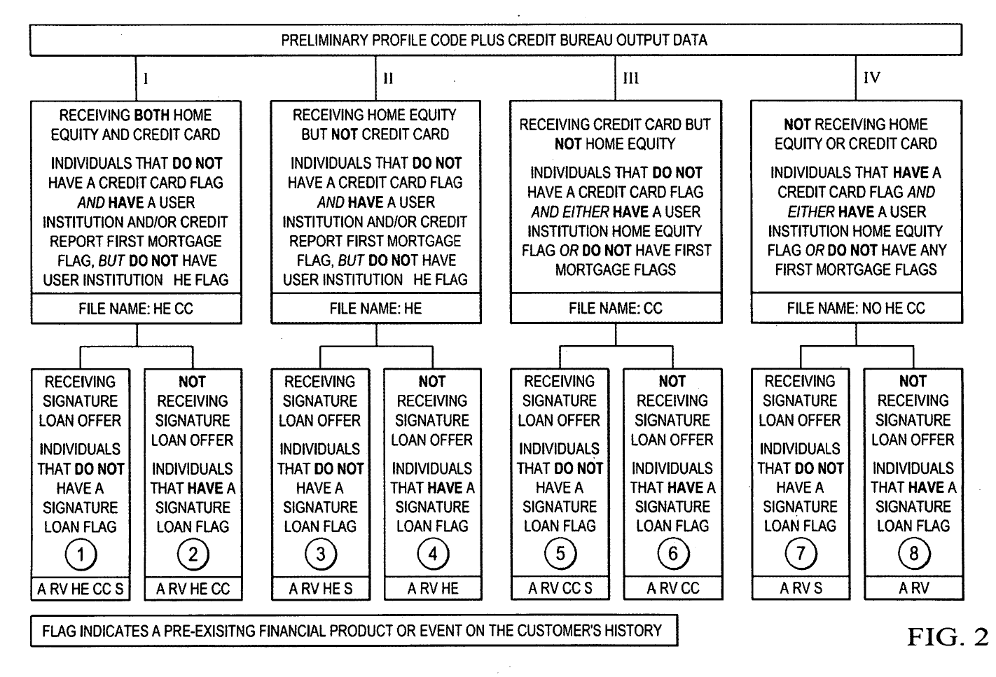

Now referring to FIG. 2, a flowchart showing how the final profile codes are created. The final profile code may be created according to different criteria and is not limited to the example shown in FIG. 2. Each preliminary profile code with the appended credit bureau data is sorted by the offers each profile may or may not obtain. This is typically done by the software program. For example, Pathway III illustrated in FIG. 2 represents the logic employed as to customers that already have a home equity loan, but not a credit card. The customers are then divided into (Box 5) those that will receive offers for signature loans and (Box 6) those that will not. Once the sorting is done, each cluster of final profile codes, having similar offer types, is given a final profile code number for future processing. In FIG. 2, the box number is also the final profile code number. The offers associated with the final profile number 6 are auto, recreational vehicle/boat/motorcycle/etc, and credit card. Along the bottom edge of each numbered box, abbreviations for the offers of each group are shown. A represents auto, RV represents recreational vehicle, boat, motorcycle, etc, HE represents home equity loan and home equity line of credit, CC represents credit card, and S represents a signature/personal/debt consolidation loan. The invention may allow for availability of more or less offers and is not limited to the examples disclosed.

The system will also preferably provide for a user-defined default set of offer(s) that customers will receive if not placed within a group. For example, Box 8 in FIG. 2 represents the default for the given example scenario. According to this example, each customer for whom data is requested from a credit bureau will at least receive offers for an auto and a type of recreational vehicle. This functionality is provided by the system to assist the user institution in complying with applicable laws and regulations which may require that an individual must be offered some form of product if a credit search is performed. One of the advantages of the system in this regard is that it analyzes all products that it has available and can provide multi-product offers to customers. This functionality allows the user institution to minimize the number of default offers it may have to send to comply with applicable laws and regulations. By using the system of the invention with this functionality, the user institution need only communicate one default offer. Previous methods required user institutions to send a default offers every time the customer was not suitable for the single-product offer intended. It should be noted that the default offer(s) is/are defined by the user and not limited to the example given.

Each cluster is then passed through a tier structure with user-defined criteria. The user institution defined risk-based lending criteria for each product being offered which has been entered into the system utilizes tiered rate structure templates. Each final profile code is compared with the lending criterion and customized variable product combinations are generated to be offered to each customer. Examples of products that may be offered via CPL include, but are not limited to: new & used auto, recreational vehicle, boat, motorcycle and aircraft loans, home equity loans and lines of credit, credit cards, unsecured loans and lines of credit, student loans, mortgage loans, overdraft lines of credit, debt consolidation loans, small business loans, etc. Another variation of this programming logic and software may be utilized to create customized multi-product insurance offers as well.

Table 1 shows an example of the tier system used by the system software. Each group, range, and/or amount is defined by the user, for example, Table 1 shows chosen credit score ranges of every ten to define each group. Each group is then related to certain percentages and amounts for given offers also defined by the user. Each profile code group is passed through this tier structure. This is where the offers become personalized. As the profile codes pass through the tier structure, each customer profile is associated with a certain group or range according to the data found in the credit bureau data and/or customer data. The user-defined percentages and amounts are then collected for the respected offers within that group or range. At this point in the process, each customer profile is personalized to each customer by the types of offers they will receive and the amounts and interest rates contained in those offers.

TABLE 1
Example Tier Structure of User-Defined Criteria

| Beacon Score 640-659 | Beacon Score 660-669 | Beacon Score 670-679 |
|---|---|---|
| Auto Loan Amount: | Auto Loan Amount: | Auto Loan Amount: |
| $20,000 | $20,000 | $25,000 |
| New Auto Loan APR: | New Auto Loan APR: | New Auto Loan APR: |
| 7.99% | 7.99% | 7.99% |
| Used Loan APR: 8.09% | Used Loan APR: 8.09% | Used Loan APR: 8.09% |
| RV Loan Amount: | RV Loan Amount: | RV Loan Amount: |
| $20,000 | $20,000 | $25,000 |
| RV APR: 8.74% | RV APR: 8.74% | RV APR: 8.74% |
| Credit Card Amount: | Credit Card Amount: | Credit Card Amount: |
| $2,500 | $2,500 | $7,500 |
| Credit Card Classic | Credit Card Classic | Credit Card Classic |
| Introductory APR: 16.90% | Introductory APR: 16.90% | Introductory APR: 7.90% |
| Credit Card Classic | Credit Card Classic | Credit Card Classic |
| Standard APR: 16.90% | Standard APR: 16.90% | Standard APR: 13.90% |
| Signature Loan Amount: | Signature Loan Amount: | Signature Loan Amount: $5,000 |
| $2,500 | $2,500 | |
| Signature Loan APR: | Signature Loan APR: | Signature Loan APR: |
| 16.99% | 16.99% | 14.99% |
| Home Equity Loan | Home Equity Loan | Home Equity Loan |
| Amount: $0 | Amount: $75,000 | Amount: $75,000 |
| HELOC Loan APR: N/A | HELOC Loan APR: | HELOC Loan APR: |
| | 7.250% Start Rate | 7.250% Start Rate |
| Fixed Rate 2nd APR: N/A | Fixed Rate 2nd APR: | Fixed Rate 2nd APR: |
| | 8.375% | 8.375% |

Additional (optional) approval criteria may be based upon any combination of information contained within the CRP. The tier structure may be based upon other criteria as previously indicated, such as the range of credit score used etc.

The system preferably further comprises a functionality to communicate offers to customers. In one embodiment, the system of the invention generates a mailing list associated with financial services offers. In a preferred embodiment, system transmits a customer mailing list to a mail house for direct mail processing and distribution. The customer mailing list preferably contains encrypted profile code and pre-approved offer (rate/loan amount/terms) information for each individual customer. The mail house decodes and utilizes this information to print customized pre-approved offers onto preprinted letter templates.

In another embodiment, the system may communicate offers via mobile device and/or populate offer communication and/or redemption fields within mobile application(s).

In another embodiment, the system may communicate offers via email. The system may assist in creating customizable email lists, transmitting emails, and tracking email marketing efforts.

In another embodiment, offers may be communicated to the customer via the Internet. For example, the customer may have a secure web page where he or she may access account information at the financial institution. This can also be used for personal communication to the customer as to pre-approved offers.

The system preferably uploads data either directly or through an intermediate transfer means to the user's customer account database. Codes corresponding to offer tracking can be associated with customer accounts.

Tracking code data can be utilized to populate a cross sell/redemption interface for use by phone center and retail sales personnel. Lending criteria may be communicated from the system to a user redemption interface to allow offer modifications based on customer redemptions.

The tracking code data can be used to populate offer communication and/or redemption fields within the user's internet banking and/or other online channel(s).

The system also preferably provides data sort and error check. The user is presented with reports including profile code quantities and any other predetermined criteria requested, such as demographic and geographic segment information, and/or performance evaluations. By knowing how many of each profile code are present, the user can determine how many individuals received a particular set of product offers, for example one profile code may indicate auto, credit card and home equity offers, while another code may indicate auto, personal loan, airplane, debt consolidation and boat offers, etc. The user is given the opportunity to perform changes to approval criteria if desired. If the user opts to make changes, the data sort and error check step is performed again. Another use of the data sort and error check functionality is that it may review any offers that do not correlate with the user's requirements, and subsequently provide the customer with the default offer(s) only. Upon user approval of data set, the system may output the offers to the customer.

Customer relationship profile (CRP) reports are generated on a user-defined basis (daily, monthly, annually, etc) and preferably uploaded or other wise transferred to the system for promotional tracking and analysis. At the completion of any promotional effort, the user may utilize a post-promotional analysis toolkit preferably contained within the system to track results, budget expense, return on investment (ROI), consumer behavior, and other parameters. The post-promotional analysis toolkit also allows the user to compare pre-approval criteria and results from past promotional efforts to help maximize the effectiveness and efficiency of future efforts.

We claim:

1. A computerized data processing system for providing customized offers to customers for financial services products, comprising:
(a) a functionality for generating a customer relationship profile for one or more customers of a user institution, said customer relationship profile generated by analyzing core data associated with one or more existing accounts of each of said customers of said user institution;
(b) a functionality for assigning a preliminary profile code to each customer relationship profile to generate a credit bureau input data set;
(c) a functionality for outputting said credit bureau input data set for communication to a credit bureau;
(d) a functionality for receiving a credit bureau output data set comprising information appended to said credit bureau input data set by said credit bureau;
(e) a functionality for generating final profile codes by analyzing said credit bureau output data set;
(f) a functionality for generating a determination based on said final profile codes, said determination comprising whether to present one or more pre-approved offers to said customer in addition to a default offer; and
(g) a functionality for communicating any of said pre-approved offers to said customer.

2. The system of claim 1, further comprising a functionality for sending said credit bureau input data set to a to a credit bureau via electronic communication from said system.

3. The system of claim 2, further comprising a functionality for receiving said credit bureau output data set.

4. The system of claim 3, wherein said functionality for receiving said credit bureau output set is capable of receiving electronic communication directly from said credit bureau which is capable of being analyzed by said system.

5. The system of claim 1, wherein said functionality for communicating interfaces with an electronic communication means which communicates offers directly to said customer.

6. The system of claim 5, wherein said electronic communication means is email.

7. The system of claim 5, wherein said electronic communication means is a secured site accessible to said customer through the Internet.

8. The system of claim 5, wherein said electronic communication means provides for transmission to a mobile device.

9. The system claim 8, wherein said mobile device is a cell phone.

10. The system of claim 1, wherein said functionality for communicating interfaces with an electronic communication means which communicates offers to an intermediary, said intermediary communicating with said customer.

11. The system of claim 10, wherein said intermediary is a direct mail house.

12. The system of claim 1, further comprising a functionality for modifying said customer relationship profiles prior to generating said credit bureau input set.

13. The system of claim 12, wherein said functionality for modifying utilizes preselected demographic criteria and said customer relationship profile to calculate a modified credit bureau input data set.

14. The system of claim 1, wherein a customer relationship profile is generated for the entire customer base of said user institution.

15. The system of claim 1, wherein said customer relationship profile is generated for multiple customers who each meet a predetermined demographic characteristic.

16. A software module comprising a program which implements
(a) a functionality for generating a customer relationship profile for one or more customers of a user institution, said customer relationship profile generated by analyzing core data associated with one or more existing accounts of each of said customers of said user institution;
(b) a functionality for assigning a preliminary profile code to each customer relationship profile to generate a credit bureau input data set;
(c) a functionality for outputting said credit bureau input data set for communication to a credit bureau;
(d) a functionality for receiving a credit bureau output data set comprising information appended to said credit bureau input data set by said credit bureau;
(e) a functionality for generating final profile codes by analyzing said credit bureau output data set;
(f) a functionality for generating a determination based on said final profile codes, said determination comprising whether to present one or more pre-approved offers to said customer in addition to a default offer: and
(g) a functionality for communicating any of said pre-approved offers to said customer.

17. A method for analyzing data for one or more customers of a user institution and generating a product offer based on criteria set by said user institution, comprising:
(a) generating a customer relationship profile for one or more customers of a user institution, said customer relationship profile generated by analyzing core data associated with one or more existing accounts of each of said customers of said user institution;
(b) assigning a preliminary profile code to each customer relationship profile to generate a credit bureau input data set;
(c) outputting said credit bureau input data set for communication to a credit bureau;
(d) receiving a credit bureau output data set comprising information appended to said credit bureau input data set by said credit bureau;
(e) generating final profile codes by analyzing said credit bureau output data set;
(f) generating a determination based on said final profile codes, said determination comprising whether to present one or more pre-approved offers to said customer in addition to a default offer: and
(g) communicating any of said pre-approved offers to said customer.

18. The method of claim 17, which is implemented by software installed on a stand alone computer.

19. The method of claim 17, which is implemented by programming provided to said institution's core processing system.

20. The method of claim 17, which is implemented by software installed by a credit bureau.
